(19) United States
(12) Patent Application Publication
(10) Pub. No.: US 2019/0079957 A1
(43) Pub. Date: Mar. 14, 2019

(54) CENTRALIZED FEATURE MANAGEMENT, MONITORING AND ONBOARDING

(71) Applicant: LinkedIn Corporation, Sunnyvale, CA (US)

(72) Inventors: Wenxuan Gao, Santa Clara, CA (US); Weiqin Ma, San Jose, CA (US); Weidong Zhang, San Jose, CA (US); Hong Lu, Fremont, CA (US)

(73) Assignee: LinkedIn Corporation, Sunnyvale, CA (US)

(21) Appl. No.: 15/702,517

(22) Filed: Sep. 12, 2017

(51) Int. Cl. G06F 17/30; G06Q 10/10

(52) U.S. Cl. CPC G06F 17/30292; G06Q 10/1053; G06F 17/30536

(57) ABSTRACT

The disclosed embodiments provide a system for processing data. During operation, the system obtains a set of features for use by a set of statistical models. Next, the system generates a schema that includes a logical description of data represented by the features and a physical description related to generating and storing the features. The system then outputs the schema for use in managing and sharing the features across the statistical models. Finally, the system updates the outputted schema to reflect one or more parameters from a user.

### RELATED APPLICATION

The subject matter of this application is related to the subject matter in a co-pending non-provisional application by the same inventors as the instant application and filed on the same day as the instant application, entitled “Automatic Feature Profiling and Anomaly Detection,” having serial number TO BE ASSIGNED, and filing date TO BE ASSIGNED (Attorney Docket No. LI-P2333.LNK.US).

### BACKGROUND

### Field

The disclosed embodiments relate to data analysis. More specifically, the disclosed embodiments relate to techniques for performing centralized feature management, monitoring and onboarding.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of statistical models. The discovered information may then be used to guide decisions and/or perform actions related to the data. For example, the output of a statistical model may be used to guide marketing decisions, assess risk, detect fraud, predict behavior, and/or customize or optimize use of an application or website.

However, significant time, effort, and overhead may be spent on feature selection during creation and training of statistical models for analytics. For example, a data set for a statistical model may have thousands to millions of features, including features that are created from combinations of other features, while only a fraction of the features and/or combinations may be relevant and/or important to the statistical model. At the same time, training and/or execution of statistical models with large numbers of features typically require more memory, computational resources, and time than those of statistical models with smaller numbers of features. Excessively complex statistical models that utilize too many features may additionally be at risk for overfitting.

Additional overhead and complexity may be incurred during sharing and organizing of feature sets. For example, a set of features may be shared across projects, teams, or usage contexts by denormalizing and duplicating the features in separate feature repositories for offline and online execution environments. As a result, the duplicated features may occupy significant storage resources and require synchronization across the repositories. Each team that uses the features may further incur the overhead of manually identifying features that are relevant to the team's operation from a much larger list of features for all of the teams.

Consequently, creation and use of statistical models in analytics may be facilitated by mechanisms for improving the profiling, management, sharing, and reuse of features among the statistical models.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3A shows an exemplary screenshot in accordance with the disclosed embodiments.

FIG. 3B shows an exemplary screenshot in accordance with the disclosed embodiments.

FIG. 4 shows a flowchart illustrating a process of profiling a set of features in accordance with the disclosed embodiments.

FIG. 5 shows a flowchart illustrating a process of managing a set of features in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

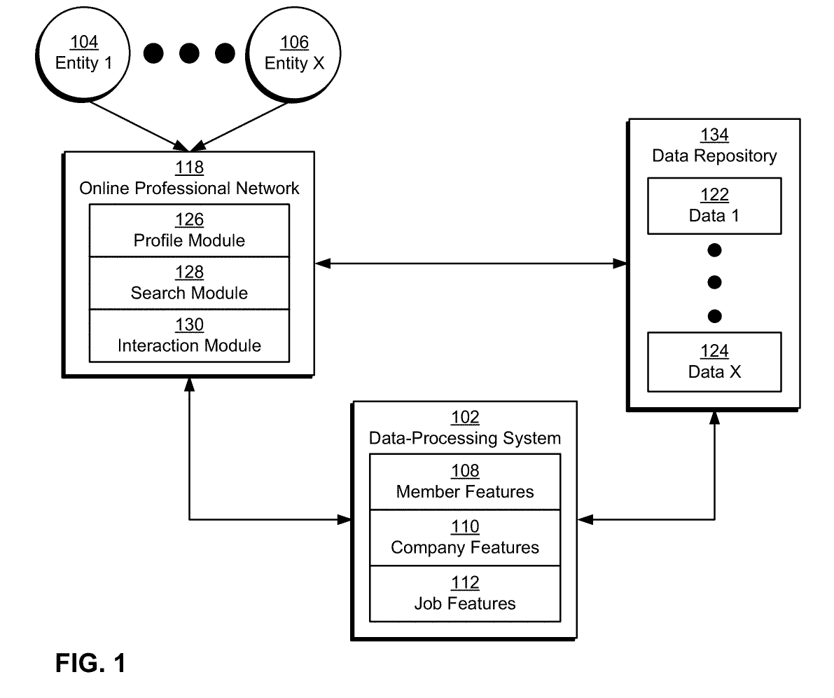

The disclosed provide a method, apparatus, and system for processing data related to a social network or other community of users. As shown in FIG. 1, the social network may include an online professional network 118 that is used by a set of entities (e.g., entity 1 104, entity x 106) to interact with one another in a professional, social, and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use the online professional network to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature of online professional network 118 to search for profiles, jobs, and/or information by categories such as first name, last name, title, company, school, location, interests, relationship, industry, groups, salary, experience level, etc.

The entities may also use an interaction module 130 to interact with other entities in online professional network 118. For example, interaction module 130 may allow an entity to add other entities as connections, follow other entities, send and receive messages with other entities, join groups, and/or interact with (e.g., create, share, re-share, like, and/or comment on) posts from other entities. Interaction module 130 may also allow the entity to upload and/or link an address book or contact list to facilitate connections, follows, messaging, and/or other types of interactions with the entity's external contacts.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, endorsement, invitation, follow, post, comment, like, share, search, click, message, interaction with a group, address book interaction, response to a recommendation, purchase, and/or other action performed by an entity in the online professional network may be tracked and stored in a database, data warehouse, cloud storage, and/or other data-storage mechanism providing data repository 134.

A data-processing system 102 may use data in data repository 134 to generate a set of member features 108, a set of company features 110, and a set of job features 112. Member features 108 may include attributes from the members' profiles with online professional network 118, such as each member's title, skills, work experience, education, seniority, industry, location, and/or profile completeness. Member features 108 may also include each member's number of connections in the social network, the member's tenure on the social network, and/or other metrics related to the member's overall interaction or “footprint” in online professional network 118. Member features 108 may further include attributes that are specific to one or more features of online professional network 118, such as a classification of the member as a job seeker or non-job-seeker.

Member features 108 may also characterize the activity of the members with online professional network 118. For example, the member features may include an activity level of each member, which may be binary (e.g., dormant or active) or calculated by aggregating different types of activities into an overall activity count and/or a bucketized activity score. Member features 108 may also include attributes (e.g., activity frequency, dormancy, total number of user actions, average number of user actions, etc.) related to specific types of social or online professional network 118 activity, such as messaging activity (e.g., sending messages within the social network), publishing activity (e.g., publishing posts or articles in the social network), mobile activity (e.g., accessing the social network through a mobile device), job search activity (e.g., job searches, page views for job listings, job applications, etc.), and/or email activity (e.g., accessing the social network through email or email notifications).

Company features 110 may include attributes and/or metrics associated with companies. For example, company features for a company may include demographic attributes such as a location, an industry, an age, and/or a size (e.g., small business, medium/enterprise, global/large, number of employees, etc.) of the company. The company features may further include a measure of dispersion in the company, such as a number of unique regions (e.g., metropolitan areas, counties, cities, states, countries, etc.) to which the employees and/or members of the online professional network from the company belong.

A portion of company features 110 may relate to behavior or spending with a number of products, such as recruiting, sales, marketing, advertising, and/or educational technology solutions offered by or through online professional network 118. For example, company features 110 may also include recruitment-based features, such as the number of recruiters, a potential spending of the company with a recruiting solution, a number of hires over a recent period (e.g., the last 12 months), and/or the same number of hires divided by the total number of employees and/or members of the online professional network in the company. In turn, the recruitment-based features may be used to characterize and/or predict the company's behavior or preferences with respect to one or more variants of a recruiting solution offered through and/or within online professional network 118.

Company features 110 may also represent a company's level of engagement with and/or presence on online professional network 118. For example, company features 110 may include a number of employees who are members of online professional network 118, a number of employees at a certain level of seniority (e.g., entry level, mid-level, manager level, senior level, etc.) who are members of online professional network 118, and/or a number of employees with certain roles (e.g., engineer, manager, sales, marketing, recruiting, executive, etc.) who are members of online professional network 118. Company features 110 may also include the number of online professional network 118 members at the company with connections to employees of online professional network 118, the number of connections among employees in the company, and/or the number of followers of the company in online professional network 118. Company features 110 may further track visits to online professional network 118 from employees of the company, such as the number of employees at the company who have visited online professional network 118 over a recent period (e.g., the last 30 days) and/or the same number of visitors divided by the total number of online professional network 118 members at the company.

One or more company features 110 may additionally be derived from member features 108. For example, company features 110 may include measures of aggregated member activity for specific activity types (e.g., profile views, page views, jobs, searches, purchases, endorsements, messaging, content views, invitations, connections, recommendations, advertisements, etc.), member segments (e.g., groups of members that share one or more common attributes, such as members in the same location and/or industry), and companies. In turn, company features 110 may be used to glean company-level insights or trends from member-level online professional network 118 data, perform statistical inference at the company and/or member segment level, and/or guide decisions related to business-to-business (B2B) marketing or sales activities.

Job features 112 may describe and/or relate to job listings and/or job recommendations within online professional network 118. For example, job features 112 may include declared or inferred attributes of a job, such as the job's title, industry, seniority, desired skill and experience, salary range, and/or location. One or more job features 112 may also be derived from member features 108 and/or company features 110. For example, job features 112 may provide a context of each member's impression of a job listing or job description. The context may include a time and location (e.g., geographic location, application, website, web page, etc.) at which the job listing or description is viewed by the member. In another example, some job features 112 may be calculated as cross products, cosine similarities, statistics, and/or other combinations, aggregations, scaling, and/or transformations of member features 108, company features 110, and/or other job features 112.

In turn, member features 108, company features 110, and/or job features 112 may be analyzed to discover relationships, patterns, and/or trends in the input data; gain insights from the input data; and/or guide decisions and/or actions related to the input data. For example, data-processing system 102 may create and train a number of statistical models for analyzing features related to members, companies, applications, job postings, purchases, electronic devices, websites, content, sensor measurements, and/or other categories. The statistical models may include, but are not limited to, regression models, artificial neural networks, support vector machines, decision trees, naïve Bayes classifiers, Bayesian networks, hierarchical models, and/or ensemble models. In turn, the statistical models may generate output that includes scores, classifications, recommendations, estimates, predictions, and/or other inferences or properties.

The output of the statistical models may be inferred or extracted from primary features and/or derived features that are generated from primary features and/or other derived features. For example, the primary features may include profile data, user activity, and/or other data that is extracted directly from fields or records in online professional network 118 and/or data repository 134. The primary features may be aggregated, scaled, combined, bucketized, and/or otherwise transformed to produce derived features, which in turn may be further combined or transformed with one another and/or the primary features to generate additional derived features. After output is generated from one or more sets of primary and/or derived features, the output may be queried and/or used to improve revenue, interaction with the users and/or organizations, job recommendations, use of the applications and/or content, and/or other metrics or targets associated with the features.

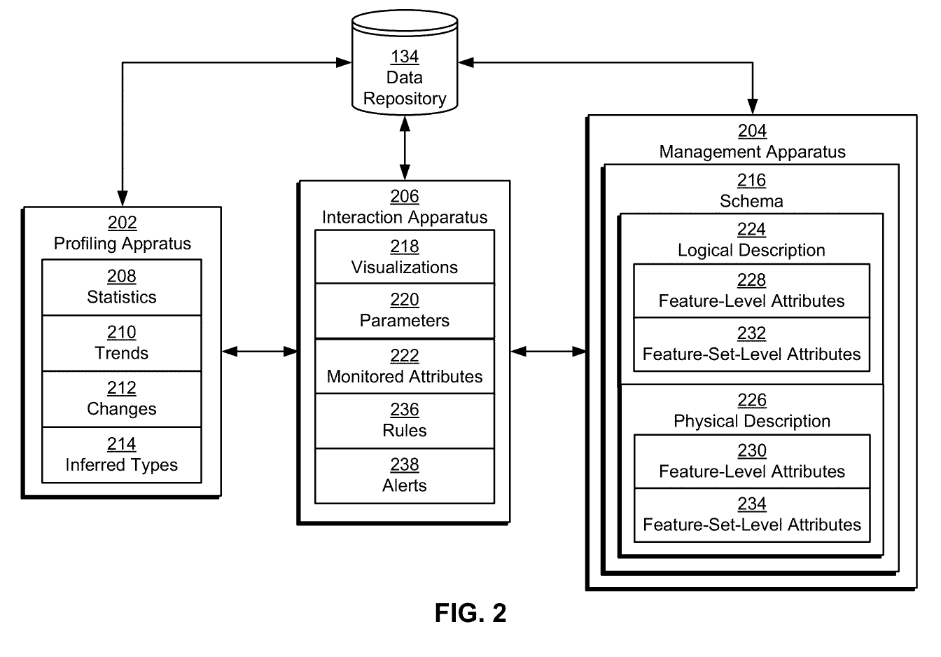

In one or more embodiments, data-processing system 102 performs centralized management, monitoring, onboarding, profiling, and/or anomaly detection for member features 108, company features 110, job features 112, and/or other types of features from data repository 134. As shown in FIG. 2, a system for processing data (e.g., data-processing system 102 of FIG. 1) may include a profiling apparatus 202, a management apparatus 204, and an interaction apparatus 206. Each of these components is described in further detail below.

As mentioned above, the system may be used to manage, monitor, create, profile, and/or detect anomalies in features such as member features, company features, and/or job features. The features may be obtained from data repository 134 and/or another data store. Alternatively, one or more components of the system may periodically generate some or all of the features from other features or raw data in data repository 134. For example, the component may aggregate and/or transform records of activity, profile data, and/or job data on a social network (e.g., online professional network 118 of FIG. 1) into member, company, and/or job features on an hourly, daily, weekly, biweekly, monthly, quarterly and/or yearly basis. The component may optionally produce a portion of the features when a pre-specified number of records has been received and/or in response to another trigger, such as user input.

After a set of features is generated and/or uploaded to data repository 134 and/or a separate feature repository, profiling apparatus 202 may perform profiling of the features. First, profiling apparatus 202 may analyze the features to collect statistics 208 and/or other informative summaries from the features. In addition, different types of statistics 208 may be generated for different feature types, which may include numeric features that store numeric values and/or categorical features that can take on a limited and/or fixed number of possible values.

Numeric features for a social network may include, but are not limited to, metrics that track activity associated with page views, clicks, messages, job listings, job searches, job applications, use of the social network by employees of a company, recruiting of job applications through the social network by the company, user sessions, connection requests, emails, interaction with content items in a content feed, and/or interaction with recommendations. The activity may be aggregated over a given time period (e.g., a day, a week, a month, etc.) and/or by other attributes (e.g., page views over a specific page, views of a group of related pages, and/or total page views for a user). The numeric features may also, or instead, include connection scores, reputation scores, propensity scores, and/or other scores calculated from other features.

Categorical features for a social network may include, but are not limited to, a language, country, industry, job function, seniority, and/or skill associated with a member, company, or job. The categorical features may also, or instead, include bucketized features that transform numeric features (e.g., number of employees, level of activity, growth rate, etc.) into ranges of values and/or a smaller set of possible values. The categorical features may optionally include binary features, which include Boolean values of 1 and 0 that indicate if a corresponding attribute is true or false. For example, binary features for a social network may have values that specify if a member is active or inactive with respect to page views, profile views, job-seeking activity, address book uploads, connection requests, advertisements, products, content, searches, and/or other types of activity within or outside the social network.

More specifically, profiling apparatus 202 may generate, for each numeric feature, statistics 208 that include a count of non-null values in the feature, a count of distinct values for the feature, a minimum value, a maximum value, a mean, a median, a mode, a standard deviation, a variance, a skew, a kurtosis, a quantile, and/or other summary statistics associated with the feature. Profiling apparatus 202 may generate, for each categorical feature, statistics 208 that include a count of non-null values and/or a histogram distribution of the non-null values in the feature.

Profiling apparatus 202 may additionally generate other types of statistics 208 and/or metadata for some or all of the features. For example, profiling apparatus 202 may include measures of correlation, similarity, and/or clustering among the features in statistics 208, in lieu of or in addition to summary statistics for individual features.

Profiling apparatus 202 may also, or instead, identify trends 210, seasonal components, and/or other components of time-series data in the features and/or statistics 208 and monitor changes 212 to the data over time (e.g., as week-over-week, month-over-month, and/or year-over-year changes). For example, profiling apparatus 202 may calculate a weekly simple moving average (SMA) and exponential moving average (EMA) from the features and/or statistics 208. In turn, the SMA and/or EMA values may be tracked and/or compared to identify trends 210 associated with the features and/or statistics 208 and/or changes 212 to the features and/or statistics 208 over time.

Profiling apparatus 202 may further generate a set of inferred types 214 from ranges of values in numeric features. In turn, statistics 208, trends 210, changes 212, and/or inferred types 214 produced by profiling apparatus 202 may be stored in data repository 134 and/or a separate repository for subsequent retrieval and use.

The operation of profiling apparatus 202 may be illustrated using the following exemplary processing steps. First, feature data for a member of a social network may be obtained from the following representation:

```
{
  “member_sk”: “32803”
  “date_sk”: “2017-03-27”
  “profile_view_1” : 1
  “profile_view_2”: 2
}
```

In the above representation, the feature data includes a member identifier (i.e., “member_sk”) of 32803 for the member and a date (i.e., “date_sk”) of “2017-03-27.” The member identifier and date are followed by two numeric features with names of “profile_view_1” and “profile_view_2” and respective values of 1 and 2. As a result, the feature data may indicate that the member with an identifier of 32803 has one record of activity of type “profile_view_1” and two records of activity of type “profile_view_2” on the date of Mar. 27, 2017.

Next, the feature data may be aggregated with feature data for other members into the following record:

```
{
  “feature_set_name”: “profile_view_agg”
  “feature_name”: “profile_view_1”
  “date_sk”: “2017-03-27”
  “statistic_name”: “count”
  “statistic_value”: 26662028
}
```

The record may identify a feature set name (i.e., “feature set_name”) of “profile_view_agg” and a feature name (i.e., “feature_name”) of “profile_view_1,” which corresponds to the first numeric feature from the member-specific feature data above. The record may also specify a statistic name (i.e., “statistic_name”) of “count” and a statistic value (i.e., “statistic_value”) of 26662028 for the numeric feature. In other words, the record may indicate that the numeric feature named “profile_view_1” in the “profile_view”agg” feature set has a non-null count of 26662028 for the date of Mar. 27, 2017.

To facilitate scaling with the volume of features in data repository 134, records containing statistics 208 and/or other feature profiling data may be partitioned into different tables based on feature name. Moreover, generation of records containing feature profiling data may be customized using configuration parameters, such as the following exemplary configuration:

```
{
  “inputPath”: “/jobs/dm2/profile_view_agg”
  “featureSetName”: “profile_view_agg”
  “featureSetGroupId”: “com.linkedin.dm2”
  “version”: “1.2.3”
  “date_sk”: “2017-03-10”
  “includeFeatureColumnRegularExpressionPattern”: “.*”
  “excludeFeatureColumnRegularExpressionPattern”:
    “member_sk | company_sk”
}
```

In the above configuration, an input path (i.e., “inputPath”) of “/jobs/dm2/profile_view_agg” is specified for the “profile_view_agg” feature set. The configuration also includes a “version” of 1.2.3 and a date (i.e., “date_sk”) of Mar. 10, 2017. Finally, the configuration specifies a regular expression of “.*” to identify features that that are to be included in the feature profiling data (i.e., “includeFeatureColumnRegularExpressionPattern”) and a regular expression of “member_sk|company_sk” to identify features that are to be excluded from the feature profiling data (i.e., “excludeFeatureColumnRegularExpressionPattern”). Because the regular expression matches the “member_sk” field in the original feature data, the field may be excluded from feature profiling data generated from the feature data.

Statistics 208 and/or other feature profiling data may then be used to generate a set of inferred types 214 based on the range of values (e.g., minimum and maximum) found in the corresponding features. An exemplary mapping of feature value ranges to inferred types 214 may include the following:

| Feature Value Range | Inferred Type |
|---|---|
| −128 to 127 | BYTEINT |
| −32,768 to 32766 | SMALLINT |
| −2,147,483,648 to 2,147,483,647 | INTEGER |
| −9,223,372,036,854,775,808 to | BIGINT |
| 9,223,372,036,854,775,807 | |
| floating point number | FLOAT |

In the above mapping, different ranges of features values are mapped to inferred types 214 that represent data types for a given data store. In turn, inferred types 214 may facilitate loading of the features from an input data source into the data store.

Finally, profiling apparatus 202 and/or another component of the system may return the feature profiling data as structured data in response to queries. For example, the component may provide a micro-service that receives a query using the following Uniform Resource Locator (URL): /summary?featurename=profile_view_1&featuresetname=profile_view_agg The above query may be used to retrieve summary statistics 208 and/or other feature profiling data associated with the “profile_view_1” feature in the “profile_view_agg” feature set. In turn, the component may generate the following response to the query:

```
{
  “count”: {
    “date_sk”: [
      “2016/09/08”,
      “2016/11/09”,
      “2016/11/27”
    ],
    “summary_val”: [
      26654363,
      27030343,
      15231491
    ]
  },
  “max”: {
    “date_sk”: [
      “2016/09/08”,
      “2016/11/09”,
      “2016/11/27”
    ],
    “summary_val”: [
      3346,
      5155,
      5037
    ]
  },
  ...
}
```

The first two components of the above response may specify a unique count (i.e., “count”) and maximum (i.e., “max”) statistics 208 for the feature. The unique count may have numeric values of 26654363, 27030343, and 15231491 for the respective dates of “2016/09/08”, “2016/11/09”, and “2016/11/27.” The maximum value may have numeric values of 3346, 5155, and 5037 for the same respective dates.

Management apparatus 204 may generate, for each feature set in data repository 134, a standardized schema 216 that is used to manage and share the feature set across teams and/or statistical models. As shown in FIG. 2, schema 216 includes a logical description 224 and a physical description 226. Both logical description 224 and physical description 226 may include feature-level attributes 228-230 that describe individual features and feature-set-level attributes 232-234 that describe the feature sets in which the features are found.

Logical description 224 may include feature-level attributes 228 and feature-set-level attributes 232 of data represented by the features. Feature-level attributes 228 in logical description 224 may include the name of a feature, a namespace that disambiguates among the usage contexts or execution environments of features with similar names, and/or a description of the feature. Feature-level attributes 228 may also include a feature type that identifies the feature as numeric, categorical, ordinal, binary, categorical bag (e.g., an ordered listing of more than one category), and/or categorical set (e.g., an unordered listing of more than one category). Similarly, feature-level attributes 228 may include a data type representing the feature as a string, integer, long, boolean, float, double, array, map, and/or other type-based classification. As discussed above, one or more data types may be obtained as inferred types 214 from profiling apparatus 202. Feature-level attributes 228 may further specify one or more aggregation attributes for the feature, such as a boolean value indicating if the feature can be aggregated (e.g., into another feature and/or statistic), an aggregation length (e.g., daily, weekly, monthly, yearly, all time, etc.), and/or an aggregation type (e.g., minimum, maximum, sum, count, average, median, mode, etc.).

Finally, feature-level attributes 228 may include a transformation option that specifies a set of possible transformations that can be applied to the feature. For example, the transformation option may include a log transformation that reduces skew in numeric values and/or a binary transformation that converts zero and positive numeric values to respective boolean values of zero and one.

Feature-set-level attributes 232 in logical description 224 may include a name of a feature set, a high-level category of the feature set (e.g., member features, company features, job features, etc.), and/or a description of the feature set. Feature-set-level attributes 232 may also identify one or more types of entities represented by features in the feature set, such as members, companies, and/or jobs. When a given type of entity is identified in feature-set-level attributes 232, an identifier and/or primary key for entities in the entity type may be included in the corresponding feature set. Feature-set-level attributes 232 may further include one or more tags that are used to classify the feature set and/or identifiers of one or more owners of the feature set.

Physical description 226 may include feature-level attributes 230 and feature-set-level attributes 234 related to generating and storing the corresponding features and feature sets. Feature-level attributes 230 in physical description 226 may include a location of a feature in a file, database, and/or other data storage format. Feature-level attributes 230 may also describe an imputation that handles missing values in the feature. For example, the imputation may add default values, such as zero numeric values or median values, to the missing values. Feature-level attributes 230 may further include a feature flag that identifies a data element as a feature or a non-feature, with data elements such as primary keys and/or timestamps flagged as non-features. Finally, feature-level attributes 230 may include a whitelist flag that indicates if a feature is whitelisted for integration within the system or not.

Feature-set-level attributes 234 in physical description 226 may include a location and/or a format of a feature set. For example, the location may be specified as a path, table name, and/or other representation that can be used to retrieve the feature set from an offline, online, and/or nearline storage system. The format may be specified as flat text, a serialization format, and/or another layout of data in the feature set. Feature-set-level attributes 234 may also include a frequency of generation (e.g., daily, weekly, monthly, etc.), a retention period for the feature set after generation (e.g., one year, two years, two months, etc.), and/or a data availability delay representing the period between collecting data and generating the feature set from the data (e.g., availability of the feature set the morning after the data is collected). Feature-set-level attributes 234 may further include a status of the feature set as certified, testing, or deprecated. Finally, feature-set-level attributes 234 may identify a source of the feature set as a path to a repository of source code and/or the name of a workflow used to generate the feature set.

To generate schema 216 for a set of features, management apparatus 204 may obtain user input and/or analyze the features or metadata associated with the features. For example, a portion of schema 216 may be provided by a creator of a feature set, and another portion of schema 216 may be derived from values of features in the feature set and/or patterns associated with the features or feature set Like feature profiling data generated by profiling apparatus 202, schema 216 may be stored in data repository 134 and/or another repository for subsequent retrieval and use.

In one or more embodiments, schema 216 is used by management apparatus 204 and/or another component of the system to automatically onboard features into data repository 134 and/or another centralized feature data store. During automatic feature onboarding, the component may obtain a portion of schema 216 for a feature set from one or more users. For example, the component may obtain a job code or workflow name, generation frequency, description, location of an input data set, location of an output repository, one or more feature owners, and/or other information in logical description 224 and physical description 226 for the feature set. The information may be obtained from a configuration file provided by the user(s), through a user interface, and/or via another communication mechanism with the user(s). The component may use the information to create a workflow for generating the feature set and integrate the newly created feature set with functionality provided by profiling apparatus 202, management apparatus 204, interaction apparatus 206, and/or other components of the system. To ensure the quality and integrity of the feature set, the component may analyze the feature set to identify and flag duplicate features and/or cyclic dependencies among features in the feature set before the feature set is loaded into the feature data store and/or integrated with other components and functionality in the system.

Interaction apparatus 206 may generate output related to the operation of profiling apparatus 202, management apparatus 204, and/or other components of the system. The output may include one or more visualizations 218 associated with statistics 208, trends 210, changes 212, inferred types 214, schema 216, and/or other data generated or maintained by profiling apparatus 202 and/or management apparatus 204. For example, visualizations 218 may include tables, spreadsheets, line charts, bar charts, histograms, pie charts, and/or other representations of feature profiling data and/or schema 216 that are displayed within a user interface and/or exported in one or more files.

Visualizations 218 may also be generated and/or updated based on one or more parameters 220. For example, interaction apparatus 206 may enable filtering, sorting, and/or grouping of data in visualizations 218 by values and/or ranges of values associated with schema 216, the features, and/or the feature profiling data.

The output may also include one or more monitored attributes 222 associated with generating and using features and feature sets within the system. Monitored attributes 222 may include a recency attribute, usage attribute, and/or distribution attribute associated with the features. The recency attribute may identify the “freshness” or availability of features in a feature set. For example, the recency attribute may be specified as one or more time intervals for which values of a feature or feature set are available. As a result, the recency attribute may facilitate selection of features and/or data ranges associated with the features during training and/or use of a statistical model with the features.

The usage attribute may track the usage of each feature in data repository 134. For example, the usage attribute may count the number of times a feature has been used as input to train, test, validate, and/or use a statistical model and/or the number of statistical models in which the feature is currently used as input. In turn, the usage attribute may facilitate decisions related to feature selection during creation of a statistical model and/or deprecation of features and/or feature sets.

The distribution attribute may include trends 210 and/or changes 212 associated with statistics 208 that describe the distribution of a feature. For example, the distribution attribute may include an SMA, EMA, and/or other value that tracks trends 210 in the feature and/or statistics 208. The distribution attribute may also, or instead, track changes 212 to trends 210 as differences in the values across different days, weeks, months, or years. The distribution attribute may thus be used to detect anomalies in the distribution, which may be caused by distribution drift and/or errors associated with generating the features.

In turn, the distribution attribute and/or other feature profiling data may be used with a set of rules 236 to detect anomalies in the features. Rules 236 may be obtained from producers and/or consumers of the features as thresholds associated with changes 212 and/or other feature profiling data. For example, a rule of “AVG(daily_member_{'}unique_ip)<5” may specify that an average value for a “daily_member_unique_ip” feature should be less than 5. If one or more rules 236 are violated, interaction apparatus 206 may generate alerts 238 and/or other notifications related to the violated rules. Continuing with the previous example, an average value for the “daily_member_unique_ip” feature that exceeds 5 may result in the transmission of an alert to one or more producers of the feature, consumers of the feature, and/or creators of the rule. In turn, users receiving the alert may perform root cause analysis of an anomaly represented by the violated rule and take actions to remedy the anomaly.

Those skilled in the art will appreciate that the system of FIG. 2 may be implemented in a variety of ways. First, profiling apparatus 202, management apparatus 204, interaction apparatus 206, and/or data repository 134 may be provided by a single physical machine, multiple computer systems, one or more virtual machines, a grid, one or more databases, one or more filesystems, and/or a cloud computing system. Profiling apparatus 202, management apparatus 204, and interaction apparatus 206 may additionally be implemented together and/or separately by one or more hardware and/or software components and/or layers. Moreover, various components of the system may be configured to execute in an offline, online, and/or nearline basis to perform different types of processing related to profiling, anomaly detection, management, monitoring, and/or onboarding associated with features and feature sets.

Second, feature profiling data, schema 216, monitored attributes 222, rules 236, and/or other data used by the system may be stored, defined, and/or transmitted using a number of techniques. For example, the system may be configured to accept features from different types of repositories, including relational databases, graph databases, data warehouses, filesystems, and/or flat files. The system may also obtain and/or transmit feature profiling data, schema 216, monitored attributes 222, rules 236, and/or other data used to manage, monitor, profile, and/or onboard features in a number of formats, including database records, property lists, Extensible Markup language (XML) documents, JavaScript Object Notation (JSON) objects, and/or other types of structured data.

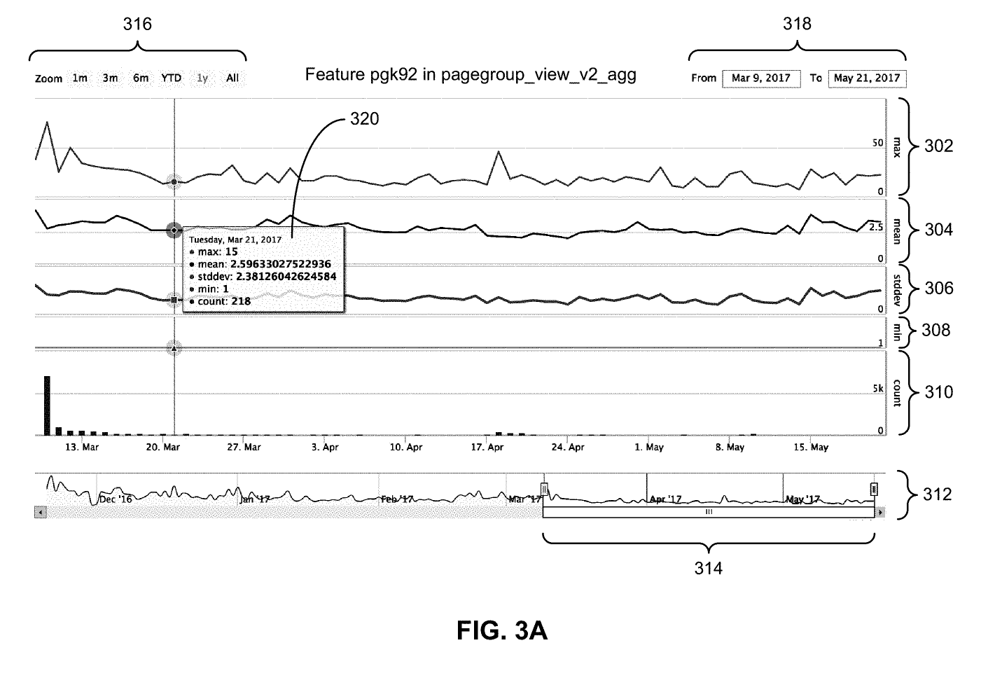

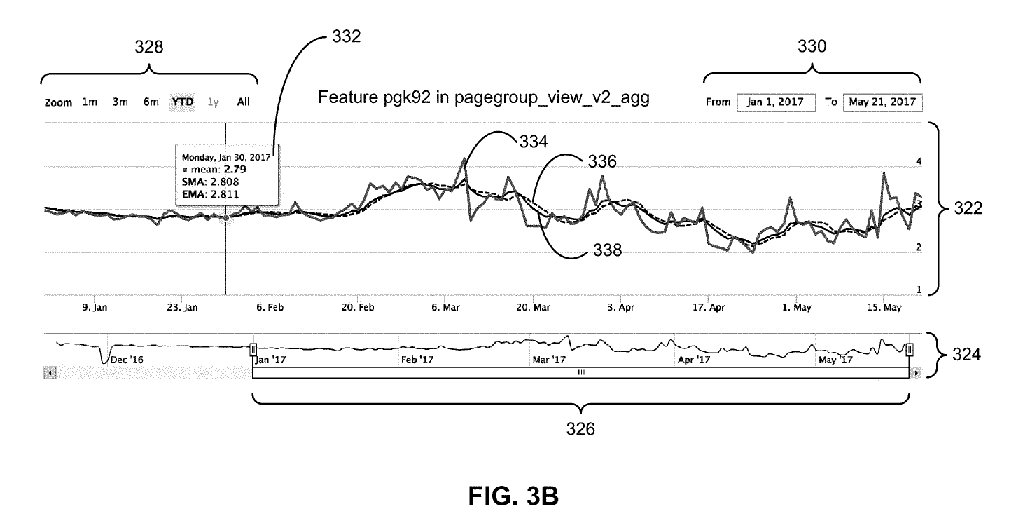

FIG. 3A shows an exemplary screenshot in accordance with the disclosed embodiments. More specifically, FIG. 3A shows a screenshot of a graphical user interface (GUI) provided by an interaction apparatus, such as interaction apparatus 206 of FIG. 2. As shown in FIG. 3A, the GUI includes a set of visualizations 302-310 associated with a feature named “pgk92” in a feature set named “pagegroup_view_v2_agg.”

Visualizations 302-310 may depict summary statistics associated with the feature, such as statistics 208 of FIG. 2. Visualizations 302-308 may be line charts of the maximum, mean, standard deviation, and minimum values of the feature, respectively. Visualization 310 may be a bar chart that shows a count of non-null values in the feature. The granularity of the statistics shown in visualizations 302-310 may be specified as using a time interval (e.g., Mar. 9, 2017 to May 21, 2017) spanned by the x-axis in visualizations 302-310.

In turn, the granularity of data shown in visualizations 302-310 may be specified using a set of user-interface elements 312-318. User-interface element 312 may display a representation of time associated with visualizations 302-308 and allow a user to select the time interval spanned by visualizations 302-310 using a slider in user-interface element 314. User-interface element 316 may include a number of options for selecting the time interval spanned by visualizations 302-310 as the last month, the last three months, the last six months, the year to date, the last year, and/or all time. User-interface element 318 may allow the user to manually enter and/or select a start and end date for the time interval.

Visualizations 302-310 may be updated based on the position of a cursor in the GUI. In particular, the GUI includes a user-interface element 320 that is displayed next to a vertical line running through visualizations 302-310. User-interface element 320 may be displayed when the cursor is positioned over a point on the vertical line. Data in user-interface element 320 may include numeric values of the maximum, mean, standard deviation, minimum, and non-null count of the feature at the time represented by the vertical line. As the cursor is moved over other points in visualizations 302-310, the vertical line and user-interface element 320 may shift to be adjacent to the point over which the cursor is currently positioned, and values in user-interface element 320 may be updated to reflect data associated with the corresponding time. Thus, user-interface element 320 may allow a user to obtain specific values of the statistics at various points in time and perform detailed analysis and assessment of the feature's distribution using the values.

FIG. 3B shows an exemplary screenshot in accordance with the disclosed embodiments. Like FIG. 3A, FIG. 3B shows a GUI provided by an interaction apparatus, such as interaction apparatus 206 of FIG. 2. Unlike FIG. 3A, the GUI of FIG. 3B includes a different visualization 322 of the same feature of “pgk92” in the feature set of “pagegroup_view_v2_agg.”

Visualization 322 may be a line chart that contains three separate lines 334-338. Line 334 may represent a mean of the feature, line 336 may represent an SMA for the mean, and line 338 may represent an EMA for the mean that is computed over the same period as the SMA (e.g., weekly). As a result, visualization 322 may be used to compare the mean of the feature with moving averages that track changes to the mean over time.

As with visualizations 302-310 of FIG. 3A, the granularity associated with visualization 322 may be adjusted by specifying a time interval spanned by visualization 322. The time interval may be obtained from a user-interface element 324 that displays a representation of time associated with visualization 322 and allows a user to select the time interval spanned by visualizations 322 using a slider in a user-interface element 326. User-interface element 328 may include a number of options for selecting the time interval as the last month, the last three months, the last six months, the year to date, the last year, and/or all time. User-interface element 330 may allow the user to manually enter and/or select a start and end date for the time interval.

Visualization 322 may additionally be updated based on the position of a cursor in the GUI. As shown in FIG. 3B, the GUI includes a user-interface element 332 that is overlaid on a vertical line running through visualization 322. User-interface element 332 may be displayed when the cursor is positioned over a point on the vertical line. Data in user-interface element 332 may include numeric values of the mean, SMA, and EMA at the time represented by the vertical line. As the cursor is moved over other points in visualization 322, the vertical line and user-interface element 332 may shift to be adjacent to the point over which the cursor is currently positioned, and values in user-interface element 332 may be updated to reflect data associated with the corresponding time.

Those skilled in the art will appreciate that the GUI of FIGS. 3A-3B may include other types and/or representations of information. For example, one or more screens of the GUI may include a table (not shown) containing logical and/or physical descriptions from schemas for features and/or feature sets associated with the visualizations. Data in the table may be filtered, sorted, and/or otherwise arranged based on search parameters and/or options associated with the table. In another example, visualizations in the GUI may include pie charts, bar charts, histograms, box plots, heat maps, and/or other graphical representations of data used to profile, manage, monitor, and/or onboard features and feature sets.

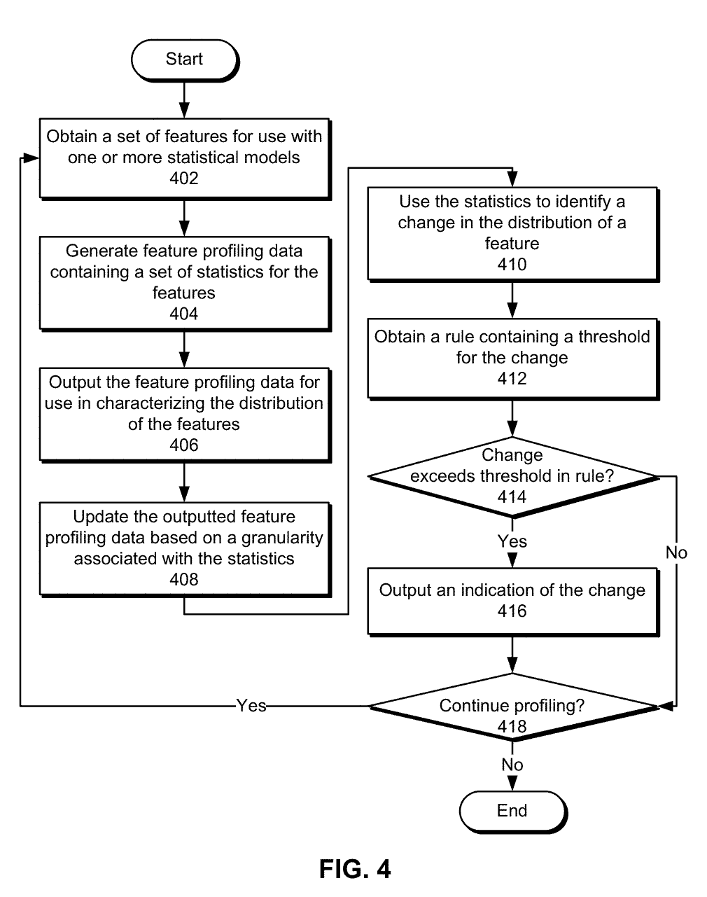

FIG. 4 shows a flowchart illustrating a process of profiling a set of features in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, the set of features is obtained for use with one or more statistical models (operation 402). For example, the features may be used to train, test, and/or validate the statistical model(s). After a statistical model is trained, tested, and/or validated, the statistical model may be applied to a portion of the features to generate output that includes scores, classifications, recommendations, estimates, predictions, and/or other inferences or properties.

Next, feature profiling data containing a set of statistics for the features is generated (operation 404). For example, the statistics may include a count of non-null values, minimum, maximum, mean, standard deviation, and/or quantile for a numeric feature. The statistics may also include a count of non-null values and a histogram distribution for a categorical feature. The statistics may further include a trend (e.g., moving average), unique count, correlation, similarity, and/or cluster associated with one or more features. The feature profiling data may additionally include a set of inferred types for the features, which are calculated from ranges of values found in the features.

The feature profiling data is then outputted for use in characterizing the distribution of the features (operation 406). For example, the feature profiling data may be displayed and/or outputted in a table, chart, spreadsheet, and/or visualization. The visualization may be displayed based on one or more parameters associated with the features. For example, the visualization may contain a set of summary statistics for a feature and/or one or more related features in the feature set. The feature and/or related features may be selected by specifying parameters such as the feature set name, one or more feature names, a category and/or namespace associated with the feature(s) or feature set, and/or feature types, data types, aggregation attributes, and/or transformation options associated with the feature(s). In general, parameters used to generate a visualization of feature profiling data may include some or all attributes provided in a schema of the feature set, such as schema 216 of FIG. 2.

The outputted feature profiling data is updated based on a granularity associated with the statistics (operation 408). For example, a visualization of the feature profiling data may be displayed with one or more user-interface elements for adjusting the granularity as a time interval spanned by the feature profiling data. When the time interval is changed, a range spanned by the visualization and/or other attributes of the visualization is updated to reflect the change. A change in one or more statistics is also displayed based on the range. For example, a time interval that spans a month may result in the display of a line chart containing statistics collected for a feature over the month. To facilitate comparison of the statistics over time, the line chart may also include a moving average associated with the statistics and/or statistics collected for the feature over previous months (e.g., the same month last year, every month for the last six months, etc.).

The feature profiling data may additionally be used to detect anomalies in the features. In particular, the statistics are used to identify a change in the distribution of a feature (operation 410). For example, the change may be identified by comparing values of one or more statistics over time. A rule containing a threshold for the change is also obtained (operation 412). For example, the rule may specify an upper and/or lower bound for a value of a feature and/or a statistic calculated from the feature.

In turn, a change in the distribution of the feature may exceed the threshold in the rule (operation 414). If the change does not exceed the threshold, the distribution may lack an anomaly represented by the rule. If the change exceeds the threshold, an indication of the change is outputted (operation 416). For example, an alert that identifies the feature, change, and/or statistical models affected by the change (e.g., statistical models that use the feature) may be transmitted to producers of the feature, consumers of the feature, and/or creators of the rule to facilitate root cause analysis and/or correction of the anomaly. The alert may link to or provide metadata associated with source code and/or workflows used to generate the feature and/or include a recommendation for remedying the change (e.g., rerunning the workflow to generate new and/or non-anomalous features, retraining the statistical models, etc.).

Profiling of features may continue (operation 418). For example, profiling may be performed for each set of features stored in and/or managed using a centralized repository. During such profiling, each set of features is obtained (operation 402), and feature profiling data is generated for the features (operation 404). The feature profiling data is then outputted and updated based on a granularity and/or other parameters associated with the features (operations 406-408). Statistics in the feature profiling data are also used to perform anomaly detection (operations 410-416) associated with the features. Profiling of features may thus continue until the features are deprecated and/or no longer used by statistical models. In turn, such profiling may automate and/or streamline the large-scale training, management, and/or use of statistical models and machine learning techniques with the features. For example, feature profiling data and/or anomaly detection in features may be used to automatically select and/or filter features for use with the statistical models and/or trigger the deprecation and/or retraining of the statistical models based on changes in the distribution of the features.

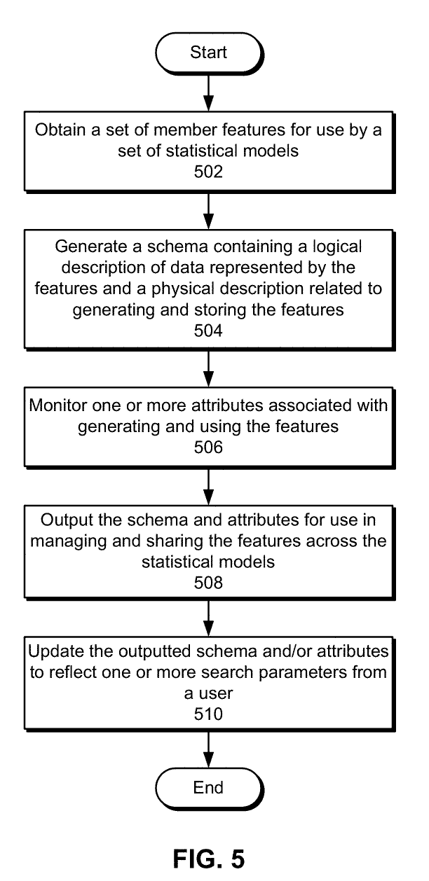

FIG. 5 shows a flowchart illustrating a process of managing a set of features in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, the set of features is obtained for use by a set of statistical models (operation 502). For example, the set of features may be stored in a centralized repository and/or data store that is accessible to creators of the statistical models. Next, a schema containing a logical description of data represented by the features and a physical description related to generating and storing the features is generated (operation 504). Fields in the schema may include feature-level attributes that describe a feature in the set of features and feature-set-level attributes that describe the set of features. For example, the feature-level attributes may include a name, namespace, description, feature type, data type, aggregation attribute, transformation option, location, imputation, feature flag, and/or whitelist flag. The feature-set-level attributes may include a name, category, description, one or more entities, one or more tags, one or more owners, location, format, frequency of generation, retention period, data availability delay, status, and/or source.

The schema may be generated in conjunction with and/or prior to obtaining the features. For example, a portion of the feature schema may be provided by one or more users and used to automatically generate the set of features from an input data set. The remainder of the schema may then be created from additional user input and/or by analyzing the generated features.

One or more attributes associated with generating and using the features are monitored (operation 506). The attributes may include a recency, usage, and/or distribution for each feature. The schema and attributes are then outputted for use in managing and sharing the features across the statistical models (operation 508). For example, the schema and/or attributes may be displayed or exported in a table, chart, spreadsheet, and/or visualization.

Finally, the outputted schema and/or attributes are updated to reflect one or more search parameters from a user (operation 510). The search parameters may include any fields in the schema and/or values or ranges of values in the attributes monitored in operation 506. As a result, the search parameters may be used to filter, group, and/or sort schemas and/or attributes across multiple features and/or feature sets. In turn, the schema and/or attributes may be used to improve, scale, and/or automate large-scale machine learning over conventional mechanisms that organize and manage separate sets of features for use in different execution environments.

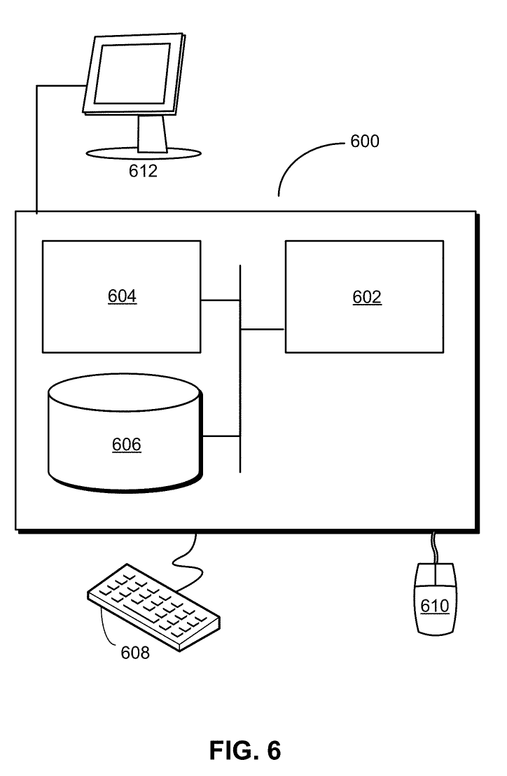

FIG. 6 shows a computer system in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system may include a profiling apparatus, a management apparatus, and an interaction apparatus, one or more of which may alternatively be termed or implemented as a module, mechanism, or other type of system component. The profiling apparatus may obtain a set of features for use with one or more statistical models. Next, the profiling apparatus may generate feature profiling data containing a set of statistics for the set of features. The interaction apparatus may output the feature profiling data for use in characterizing a distribution of the features and update the outputted feature profiling data based on a granularity associated with the statistics.

The management apparatus may generate a schema containing a logical description of data represented by the features and a physical description related to generating and storing the features. The interaction apparatus may output the schema for use in managing and sharing the features across the statistical models and update the outputted schema to reflect one or more parameters from a user.

In addition, one or more components of computer system 600 may be remotely located and connected to the other components over a network. Portions of the present embodiments (e.g., profiling apparatus, management apparatus, interaction apparatus, data repository, etc.) may also be located on different nodes of a distributed system that implements the embodiments. For example, the present embodiments may be implemented using a cloud computing system that performs profiling, anomaly detection, management, monitoring, and/or onboarding of features for use by a set of remote statistical models.

By configuring privacy controls or settings as they desire, members of a social network, an online professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of features for use by a set of statistical models;
generating, by a computer system, a schema comprising:
a logical description of data represented by the features; and
a physical description related to generating and storing the features;
outputting the schema for use in managing and sharing the features across the statistical models; and
updating the outputted schema to reflect one or more parameters from a user.

2. The method of claim 1, wherein obtaining the set of features comprises:
obtaining a portion of the schema from one or more users; and
using the portion of the schema to automatically generate the set of features.

3. The method of claim 1, further comprising:
monitoring one or more attributes associated with generating and using the features; and
outputting the one or more attributes with the schema.

4. The method of claim 3, wherein the one or more attributes comprise at least one of:
a recency;
a usage; and
a distribution.

5. The method of claim 1, wherein the logical description and the physical description of the schema comprise:
feature-level attributes that describe a feature in the set of features; and
feature-set-level attributes that describe the set of features.

6. The method of claim 5, wherein the feature-set-level attributes in the logical description comprise:
a name;
a category;
a description;
one or more entities;
one or more tags; and
one or more owners.

7. The method of claim 5, wherein the feature-level attributes in the logical description comprise:
a name;
a namespace;
a description;
a feature type;
a data type;
an aggregation attribute; and
a transformation option.

8. The method of claim 5, wherein the feature-set-level attributes in the physical description comprise:
a location;
a format;
a frequency of generation;
a retention period;
a data availability delay;
a status; and
a source.

9. The method of claim 5, wherein the feature-level attributes in the physical description comprise:
a location;
an imputation;
a feature flag; and
a whitelist flag.

10. The method of claim 1, wherein the schema is generated from:
user input; and
metadata associated with the features.

11. The method of claim 1, wherein the set of features comprises:
a member feature for a member of a social network;
a company feature for a company; and
a job feature for a job at the company.

12. A system, comprising:
one or more processors; and
memory storing instructions that, when executed by the one or more processors, cause the apparatus to:
obtain a set of features for use by a set of statistical models;
generate a schema comprising:
a logical description of data represented by the features; and
a physical description related to generating and storing the features;
output the schema for use in managing and sharing the features across the statistical models; and
update the outputted schema to reflect one or more parameters from a user.

13. The system of claim 12, wherein obtaining the set of features comprises:
obtaining a portion of the schema from one or more users; and
using the portion of the schema to automatically generate the set of features.

14. The system of claim 12, wherein the memory further stores instructions that, when executed by the one or more processors, cause the apparatus to:
monitor one or more attributes associated with generating and using the features; and
output the one or more attributes with the schema.

15. The system of claim 14, wherein the one or more attributes comprise at least one of:
a recency;
a usage; and
a distribution.

16. The system of claim 12, wherein the logical description and the physical description of the schema comprise:
feature-level attributes that describe a feature in the set of features; and
feature-set-level attributes that describe the set of features.

17. The system of claim 16, wherein the feature-set-level attributes comprise at least one of:
a name;
a category;
a description;
one or more entities;
one or more tags;
one or more owners;
a location;
a format;
a frequency of generation;
a retention period;
a data availability delay;
a status; and
a source.

18. The system of claim 16, wherein the feature-level attributes comprise at least one of:
a location;
an imputation;
a feature flag;
a whitelist flag;
a name;
a namespace;
a description;
a feature type;
a data type;
an aggregation attribute; and
a transformation option.

19. A non-transitory computer-readable storage medium storing instructions that when executed by a computer cause the computer to perform a method, the method comprising:
obtaining a set of features for use by a set of statistical models;
generating a schema comprising:
a logical description of data represented by the features; and
a physical description related to generating and storing the features;
outputting the schema for use in managing and sharing the features across the statistical models; and
updating the outputted schema to reflect one or more parameters from a user.

20. The system of claim 19, wherein obtaining the set of features comprises:
obtaining a portion of the schema from one or more users; and
using the portion of the schema to generate the set of features.
